(19) United States
(12) Patent Application Publication
(10) Pub. No.: US 2007/0265555 A1
(43) Pub. Date: Nov. 15, 2007

(54) Hand tool for enhancing blood circulation of tooth root and gum

(76) Inventor: Connie Zuchu Deng, Hacienda Height, CA (US)

Correspondence Address: Raymond Y. Chan, Suite 128, 108 N. Ynez Avenue, Monterey Park, CA, 91770, US

(21) Appl. No.: 11/801,929

(22) Filed: May 11, 2007

Related U.S. Application Data
(60) Provisional application No. 60/799,932, filed on May 12, 2006.

(51) Int. Cl. A61H 13/00

(52) U.S. Cl. 601/141; 601/139; 601/136

(57) ABSTRACT

A hand tool for enhancing blood circulation of tooth root and gum includes an elongated main body, an enlarged supporting base extended from a free end of the main body, and a plurality of massaging elements spacedly extended from a supporting surface of the supporting base adapted for massaging the tooth root and gum so as to enhance blood circulation of gum, improve health thereof, and reduce possibility of oral diseases.

### BACKGROUND OF THE PRESENT INVENTION

1. Field of Invention

The present invention is related to a massager, ad more particularly to a hand tool for enhancing blood circulation of tooth root and gum. By appropriately massaging the gum, the hand tool is capable of enhancing blood circulation of the gum and further improving health thereof.

2. Description of Related Arts

In addition to brushing the teeth in a correct manner, properly massaging the gum is another way to improve health of the teeth. Healthy gum is the fundamental to healthy teeth and only healthy gum can provide a clean environment for the roots of the teeth.

However, people usually focus on how to clean the teeth and ignore to massage the gum, and thus bad circulation of blood is likely to occur and resistance against oral diseases is decreased. Furthermore, some oral diseases such as gingivitis, recession of gum, and periodontal disease are easy to take place due to ignorance of massaging the gum.

In addition, even though some people would somewhat massage their gums while brushing the teeth, the tips of the traditional toothbrushes are a little sharper. Thus, it is not helpful for massaging the gum in this manner. Moreover, when brushing with great force, it is easy to cause injury on either the gum or enamel of the tooth because of unnecessarily huge friction thereon.

Also, a traditional toothbrush only has one brushing head and the brushes are located thereon. Moreover, for the toothbrush with only one brushing head, if the volume of the brushing head is too big, it is not easy to clean the interior surface of the teeth and the gum. More seriously, it causes dead angles of oral cleaning. If the brushing head is too small, the user has to spend more time in cleaning.

### SUMMARY OF THE PRESENT INVENTION

The main object of the present invention is to provide a hand tool for enhancing blood circulation of tooth root and gum, wherein a plurality of massaging elements is placed on the main body of the tool so that when the tool is moving back and forth on the gum, the massaging elements are rolling over thereon to massage the gum to enhance blood circulation of the gum and further improve health thereof, and reduce the possibility of oral diseases.

Another object of the present invention is to provide a hand tool for enhancing blood circulation of tooth root and gum, wherein the shape of the top of the massaging elements is arc so that the user feels more comfortable during massaging. Also, the gum and the teeth are unlikely to be damaged during the cleaning and massaging process since no unnecessarily huge friction exerted.

Another object of the present invention is to provide a hand tool for enhancing blood circulation of tooth root and gum, wherein the main body of the tool comprises two ends and each end has a brushing head with different sizes compared to each other. While cleaning the teeth, the user can choose either larger or smaller brushing head based on the location of the gum so that the tool can provide the best way to clean and massage the gum everywhere in the mouth and further eliminate the dead angles.

Accordingly, in order to accomplish the above objects, the present invention provides a hand tool for enhancing blood circulation of tooth root and gum, comprising an elongate main body with two ends and at least one end forming a supporting base, wherein a plurality of massaging elements is installed. While the tool moves back and forth on the gum, the massaging elements are rolling over correspondingly in the same manner thereon to enhance blood circulation of the gum, to improve the heath of the gum, and to reduce possibility of oral diseases.

### BRIEF DESCRIPTION OF THE DRAWINGS

FIG. 1A is a perspective view of a hand tool according to a preferred embodiment of the present invention.

FIG. 1B is a partially perspective view of the first massaging elements of the hand tool according to the above preferred embodiment of the present invention.

FIG. 2 is a partially side view of the hand tool according to the above preferred embodiment of the present invention.

FIG. 3 illustrates a first alternative mode of the hand tool according to the above preferred embodiment of the present invention.

FIG. 4 illustrates a second alternative mode of the hand tool according to the above preferred embodiment of the present invention.

FIG. 5 illustrates the hand tool placing in an oral cavity according to the above preferred embodiment of the present invention.

FIG. 6 illustrates the hand tool cleaning and massaging the gum at the interior of the teeth according to the above preferred embodiment of the present invention.

### DETAILED DESCRIPTION OF THE PREFERRED EMBODIMENT

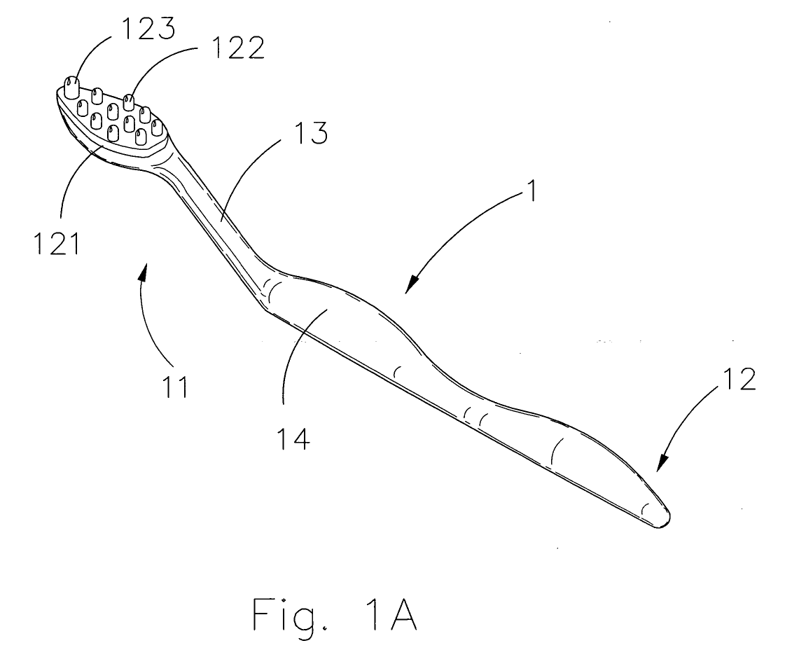

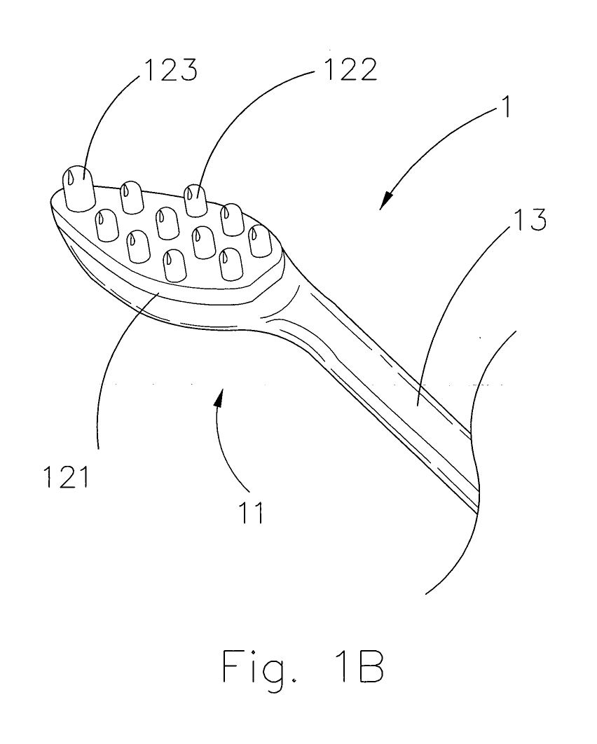

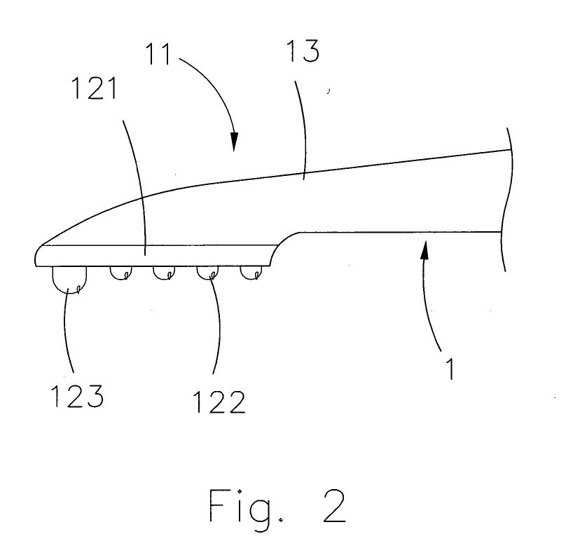

Referring to FIGS. 1A, 1B, and 2, a preferred embodiment of a hand tool for enhancing blood circulation of tooth root and gum is provided. The hand tool comprises an elongate main body 1 having a first end 11 and a second end 12. The first end 11 forms a first supporting base 121, wherein a plurality of first massaging elements 122 is placed thereon.

The first supporting base 121, having a rectangular shape, is an enlarged member integrally extended from the first end 11 as the free end of the main body 1, wherein the first supporting base 121 has a flat supporting surface for the first massaging elements 122 spacedly extended thereon.

The first massaging elements 122 are cylinder-shaped and the shape of the free ends is either arc or hemisphere, wherein the first massaging elements 122 are made by soft materials, such as plastic or rubber, so that the elements are flexible and easy to be bended. In other words, each of the first massaging elements 122 has a round head to massage the tooth root and gum.

While using the hand tool in the present invention, the hand tool moves back and forth on the gum and the first massaging elements 122 follow the movement of the hand tool, bending inward and outward continuously. This rolling movement not only provides the function of cleaning, but also eliminates unwanted matters from the interstices of the first massaging elements 122. The gentle and non-irritating friction between the gum and the massaging elements 122 is able to enhance blood circulation of the gum and improve health thereof.

Furthermore, the front end of the first supporting base 121 comprises a third massaging element 123 extended on the supporting surface of the first supporting base 121 at a position adjacent to the first massaging element 122, wherein the outer diameter thereof is larger than the first massaging element 122 and the height of the third massaging element 123 is taller than the first massaging element 122 as well. By using the third massaging element 123, the hand tool in the present invention can also massage the gum in the rear end of the mouth. Accordingly, the third massaging element 123 which is made of soft and flexible material, also has a round head for massage the tooth root and gum.

Referring to FIG. 1A, a first neck portion 13 is inclinedly formed between the middle portion of the main body 1 and the first supporting base 121, wherein the middle portion of the main body forms a handling bar 14 having a hand gripping surface so as to allow the user to comfortably hold the main body 1.

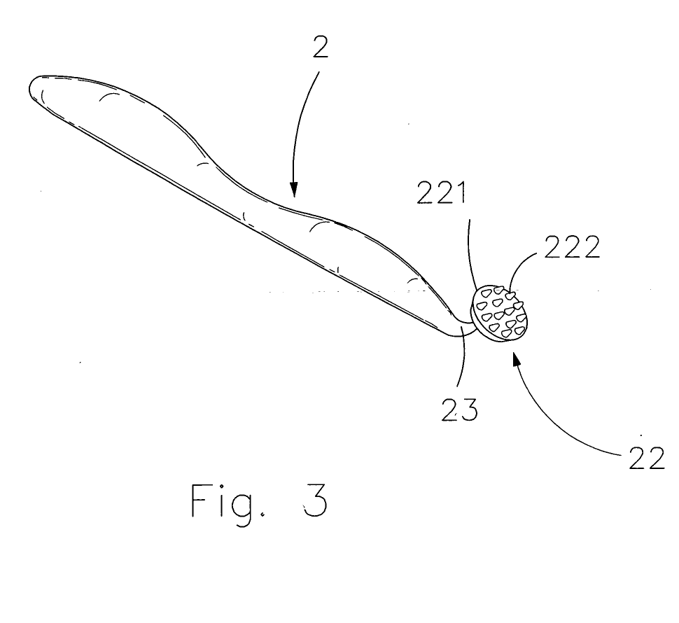

Another preferred embodiment is provided in FIG. 3, wherein a second end 22 on a main body 2 forms a second supporting base 221 and a plurality of second massaging elements 222 is placed thereon. The second massaging elements 222 are cone-shaped and the shape of the top of each of the second massaging elements 222 is arc or hemisphere, wherein the second massaging element 222 is made by soft materials such as rubber or plastic, so that the elements are flexible and easy to be bended.

The second supporting base 221, having a circular shape, is an enlarged member integrally extended from the second end 22 as the free end of the main body 2, wherein the second supporting base 221 has a flat supporting surface for the second massaging elements 222 spacedly extended thereon. Accordingly, each of the second massaging elements 222 has a round apex to massage the tooth root and gum.

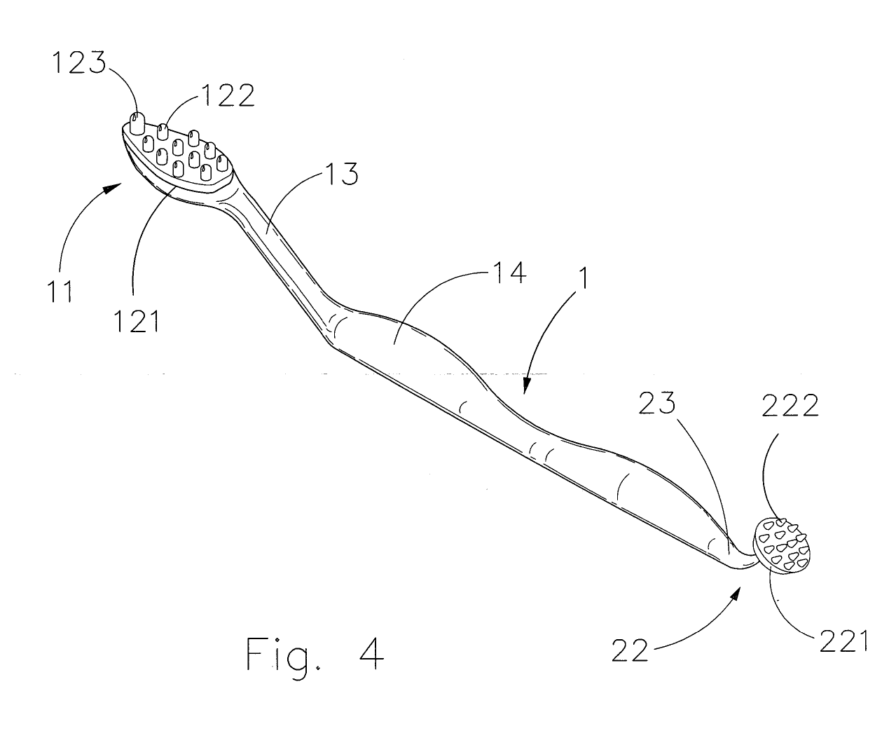

FIG. 4 illustrates the combination of the above two embodiments of the hand tool. Accordingly, the main body 1 has first and second ends 11, 22, wherein the first and the second supporting bases 121 and 221 are respectively placed on the main body 1 at the first and second ends 11, 22 respectively, so as to allow the user to use different tools while massaging different locations of the gum. Thus, the convenience and the effect of massaging the gum are both improved.

As shown in FIG. 4, the size of the second supporting base 221 is smaller than the first supporting base 121, and the second massaging elements 221 on the second supporting base 221 are smaller than that on the first supporting base 121. The size of each of the first massaging elements 121 is larger than a size of each of the second massaging elements 222. The third massaging element 123 is formed at the front end of the first supporting base 121, wherein the outer diameter thereof is larger than the first massaging element 122 and the height of the third massaging element 123 is higher than the first massaging element 122 as well. Also, the first neck portion 13 is formed between the main body 1 and the first supporting base 121 while the second neck portion 23 is inclinedly formed between the main body 1 and the second supporting base 221. The handling bar 14, having a hand gripping surface, is integrally formed between the first and second neck portions 13, 23. It is worth to mention that since the size of the first supporting base 121 is larger than that of the second supporting base 221, the user is able to select the main body 1 with the first supporting base 122 thereat to massage the tooth root and gum via the first and third massaging elements 122, 123 and to select the main body 1 with the second supporting base 221 thereat to massage the oral cavity and the tooth root and gum behind the teeth via the second massaging elements 222.

Accordingly, each of the first, second, and third massaging elements 122, 222, 123 is made of silicon or rubber or has a silicon or rubber layer coated on the outer surface such that when the first, second, and third massaging elements 122, 222, 123 rub on the tooth root and/or gum, the first, second, and third massaging elements 122, 222, 123 can massage the tooth root and gum for enhancing blood circulation thereof.

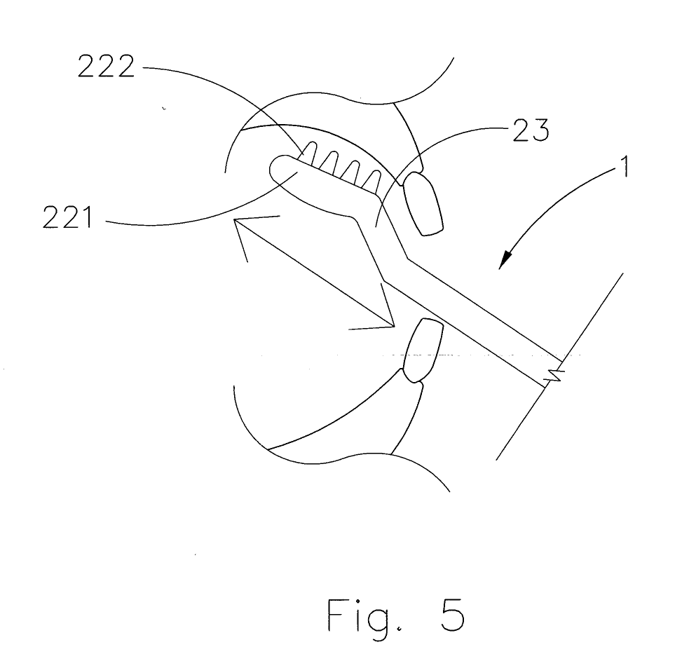

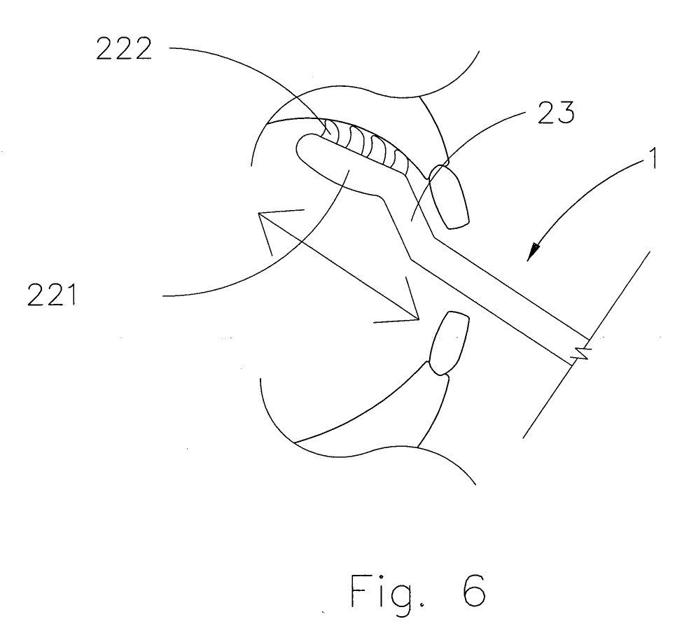

As can be seen in FIG. 5, the dead angle can be eliminated by using smaller hand tool to clean and massage the gum at the oral cavity, wherein the second massaging elements 222 on the second supporting base 221 can be placed appropriately at the oral cavity. While the smaller hand tool moves back and forth as a rubbing action on the gum at the oral cavity, the second massaging elements 222 continuously roll over thereon to enhance blood circulation, as shown in FIG. 6.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A hand tool for enhancing blood circulation of tooth root and gum, comprising:
an elongated main body having one free end;
an enlarged supporting base, having a supporting surface, extended from said free end of said main body; and
a plurality of massaging elements spacedly extended from said supporting surface of said supporting base adapted for massaging said tooth root and gum so as to enhance blood circulation of gum, improve health thereof, and reduce possibility of oral diseases.

2. The hand tool, as recited in claim 1, wherein each of said massaging element, which is made of soft and flexible material, has a cylindrical shape and a round head for massage the tooth root and gum.

3. The hand tool, as recited in claim 1, further comprising an additional massaging element extended from a front end of said supporting surface of said supporting base at a position adjacent to said first massaging element, wherein a height of said additional message element is taller than a height of each of said first massaging elements.

4. The hand tool, as recited in claim 2, further comprising an additional massaging element extended from a front end of said supporting surface of said supporting base at a position adjacent to said first massaging element, wherein a height of said additional message element is taller than a height of each of said first massaging elements.

5. The hand tool, as recited in claim 3, wherein each of said massaging element and said additional massaging element has a cylinder structure, wherein a diameter of said additional massaging element is larger than that of each of said first massaging elements.

6. The hand tool, as recited in claim 4, wherein each of said massaging element and said additional massaging element has a cylinder structure, wherein a diameter of said additional massaging element is larger than that of each of said first massaging elements.

7. The hand tool, as recited in claim 1, wherein each of said massaging element, which is made of soft and flexible material, has a cone shape and a round apex for massage the tooth root and gum.

8. The hand tool, as recited in claim 1, further comprising an enlarged supplemental supporting base, having a supplemental supporting surface, integrally extended from an opposed end of said main body and a plurality of supplemental massaging elements spacedly extended from said supplemental supporting surface of said supplemental supporting base, wherein a size of each of said massaging elements is larger than a size of each of said supplemental massaging elements, wherein a size of said supplemental supporting base is smaller than that of said supporting base.

9. The hand tool, as recited in claim 4, further comprising an enlarged supplemental supporting base, having a supplemental supporting surface, integrally extended from an opposed end of said main body and a plurality of supplemental massaging elements spacedly extended from said supplemental supporting surface of said supplemental supporting base, wherein a size of each of said massaging elements is larger than a size of each of said supplemental massaging elements, wherein a size of said supplemental supporting base is smaller than that of said supporting base.

10. The hand tool, as recited in claim 6, further comprising an enlarged supplemental supporting base, having a supplemental supporting surface, integrally extended from an opposed end of said main body and a plurality of supplemental massaging elements spacedly extended from said supplemental supporting surface of said supplemental supporting base, wherein a size of each of said massaging elements is larger than a size of each of said supplemental massaging elements, wherein a size of said supplemental supporting base is smaller than that of said supporting base.

11. The hand tool, as recited in claim 8, wherein each of said supplemental massaging element, which is made of soft and flexible material, has a cone shape and a round apex for massage the tooth root and gum.

12. The hand tool, as recited in claim 9, wherein each of said supplemental massaging element, which is made of soft and flexible material, has a cone shape and a round apex for massage the tooth root and gum.

13. The hand tool, as recited in claim 10, wherein each of said supplemental massaging element, which is made of soft and flexible material, has a cone shape and a round apex for massage the tooth root and gum.

14. The hand tool, as recited in claim 11, wherein said massaging elements and said supplemental massaging elements are made of silicon for rubbing on said tooth root and gum.

15. The hand tool, as recited in claim 12, wherein said massaging elements and said supplemental massaging elements are made of silicon for rubbing on said tooth root and gum.

16. The hand tool, as recited in claim 13, wherein said massaging elements and said supplemental massaging elements are made of silicon for rubbing on said tooth root and gum.

17. The hand tool, as recited in claim 13, wherein said main body further has a first neck portion inclinedly extended from said supporting base and a second neck portion inclinedly extended from said supplemental supporting base.

18. The hand tool, as recited in claim 16, wherein said main body further has a first neck portion inclinedly extended from said supporting base and a second neck portion inclinedly extended from said supplemental supporting base.

19. The hand tool, as recited in claim 17, wherein said main body further comprises a handling bar, having a hand gripping surface, integrally extended between said first and second neck portions.

20. The hand tool, as recited in claim 17, wherein said main body further comprises a handling bar, having a hand gripping surface, integrally extended between said first and second neck portions.
